(19) United States
(12) Patent Application Publication
(10) Pub. No.: US 2011/0000354 A1
(43) Pub. Date: Jan. 6, 2011

(54) RAIL CUT-OFF MACHINE OR THE LIKE

(76) Inventor: Maurice Huboud-Peron, La Tour Du Pin (FR)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 12/521,350

(22) PCT Filed: Dec. 12, 2007
(86) PCT No.: PCT/FR2007/002046

§ 371 Date: Sep. 15, 2010

(30) Foreign Application Priority Data
Dec. 27, 2006 (FR) 0611453

(51) Int. Cl. B23D 45/04; B23D 47/12

(52) U.S. Cl. 83/743; 83/478; 83/490

(57) ABSTRACT

The cut-off machine (2) of the present invention includes an engine block (3) for driving via a belt (5) a cutting disk (6) attached to a disk carrier (7), an axis sheath (8) parallel to the axis of the cutting disk and to be secured on a bearing and guiding device of the cut-off machine, including a clamp for fixation to the rail and permitting the pivoting of the cut-off machine in the plane of the cutting disk, characterised in that the sheath and the disc carrier define a single block (9) mounted on the engine block (3) with elastic means provided in-between.

### BACKGROUND OF THE INVENTION AND DESCRIPTION OF THE PRIOR ART

The present invention relates to a cut-off machine for rails or the like.

Document FR 2 267 418 describes a cut-off machine for rails or the like, comprising a drive unit driving, via a belt, a cutting disk fixed to a disk holder, a sleeve of axis parallel to the axis of the cutting disk, intended to be fixed to a support and guidance device for supporting and guiding the cut-off machine and comprising a vise for attachment to the rail and allowing the cut-off machine to pivot in the plane of the cutting disk.

A first disadvantage with this type of cut-off machine lies in the fact that it is unable to make cuts perpendicular to the rail with a satisfactory quality of cut.

This is because the vibrations caused by the motor and the stresses applied by the user to the cut-off machine are transmitted directly to the cutting disk, which means that the cutting disk cannot be kept in a plane perpendicular to the rail and a satisfactory quality of cut cannot therefore be obtained.

A second disadvantage with this type of cut-off machine is that the vibrations generated by the motor and transmitted to the cutting disk lead to rapid disk wear. Thus, cutting disk life is very short, entailing regular replacement of cutting disks. This rapid wearing of the cutting disk greatly increases the cost and the length of the cutting operation.

A third disadvantage with this type of cut-off machine lies in the fact that significant vibration generated by the motor and the cutting disk is transmitted to the user during the cutting operation, this being something that is highly prejudicial to user comfort and safety.

The present invention aims to remedy these disadvantages.

### SUMMARY OF THE INVENTION

The technical problem addressed by the invention is therefore that of providing a cut-off machine able to improve the quality of cut of the rails, and to reduce the rate of wear of the cutting disk while at the same time improving user comfort and safety.

To this end, the present invention relates to a cut-off machine for rails or the like, of the type described hereinabove, wherein the sleeve and the disk holder form a one-piece assembly mounted on the drive unit with the interposition of elastic means.

Creating a one-piece assembly comprising the sleeve intended to be fixed to a device for supporting and guiding the cut-off machine and the disk holder allows the cutting disk to be kept firmly in a determined plane when the sleeve is fixed to a device for supporting and guiding the cut-off machine. This makes it possible to limit the vibrations generated by the cutting disk and therefore to obtain an improved quality of cut and to reduce the rate of wear of the cutting disk.

In addition, the elastic means are designed to deform elastically when stresses are applied to the cut-off machine by the user or when vibrations are generated by the motor so that these stresses and vibrations are not transmitted to the cutting disk.

Thus, the presence of these elastic means further improves the quality of cut of the cut-off machine.

Further, the presence of these elastic means makes it possible to avoid transmitting to the operator the vibrations generated by the cutting disk and therefore improves user comfort and safety.

Advantageously, the one-piece assembly comprises a mounting plate bearing the sleeve and a bearing for mounting a cutting disk driveshaft.

As a preference, the cutting disk driveshaft projects on each side of the bearing, a drive pulley collaborating with the belt of the drive unit being fixed to a first end of the driveshaft and a disk attachment device being fixed to the other end of the driveshaft.

Advantageously, the elastic means have lower elasticity in the direction in which the belt is tensioned than they do in the other directions. This feature makes it possible to avoid too great a reduction in the inter-axis distance between the axes of the motor pulley and of the cutting disk drive pulley. As a result, the motor belt can be kept under enough tension that it can drive the disk drive pulley.

As a preference, the elastic means comprise at least one elastic element, such as a block or a sheet, positioned between the drive unit and the mounting plate of the one-piece assembly. It should be noted that the elastic elements may be blocks which may adopt various shapes and/or cross sections along their length, it being possible for example for the blocks to be cylindrical, frustoconical, parallelepipedal, or diabolo-shaped. The blocks or sheets may be made of natural or synthetic rubber or any other synthetic material.

According to yet another feature of the invention, the drive unit comprises a first part containing the motor of the cut-off machine and a second part on which the one-piece assembly is mounted, the second part being movable with respect to the first part so as to allow the cutting disk drive belt to be tensioned sufficiently, locking means being provided for locking the relative position of the first and second parts.

Advantageously, the cut-off machine comprises at least one elastic element running at right angles to the plane of the cutting disk, the elastic element being positioned between the second part of the drive unit and the mounting plate of the one-piece assembly.

As a preference, the cut-off machine comprises at least one elastic element running parallel to the plane of the cutting disk, the elastic element being positioned between the second part of the drive unit and the mounting plate of the one-piece assembly.

According to another feature of the invention, each elastic element running at right angles to the plane of the cutting disk has greater elasticity than each elastic element running parallel to the plane of the cutting disk.

According to yet another feature of the invention, a protective disk guard is fixed to the mounting plate.

### BRIEF DESCRIPTION OF THE DRAWINGS

In any event, the invention will be clearly understood with the aid of the description which follows, with reference to the annotated schematic drawing which, by way of nonlimiting example, depicts one embodiment of this cut-off machine.

FIG. 1 is a side view thereof.

FIG. 2 is a partial view thereof from above.

FIG. 3 is a side view of the one-piece assembly.

FIG. 4 is a partial side view of the cut-off machine from which the one-piece assembly has been removed.

FIG. 5 is a partial side view of the cut-off machine from which the cutting disk and the protective guard have been removed.

FIG. 6 is a side view of a device for supporting and guiding the cut-off machine.

### DESCRIPTION OF THE PREFERRED EMBODIMENT

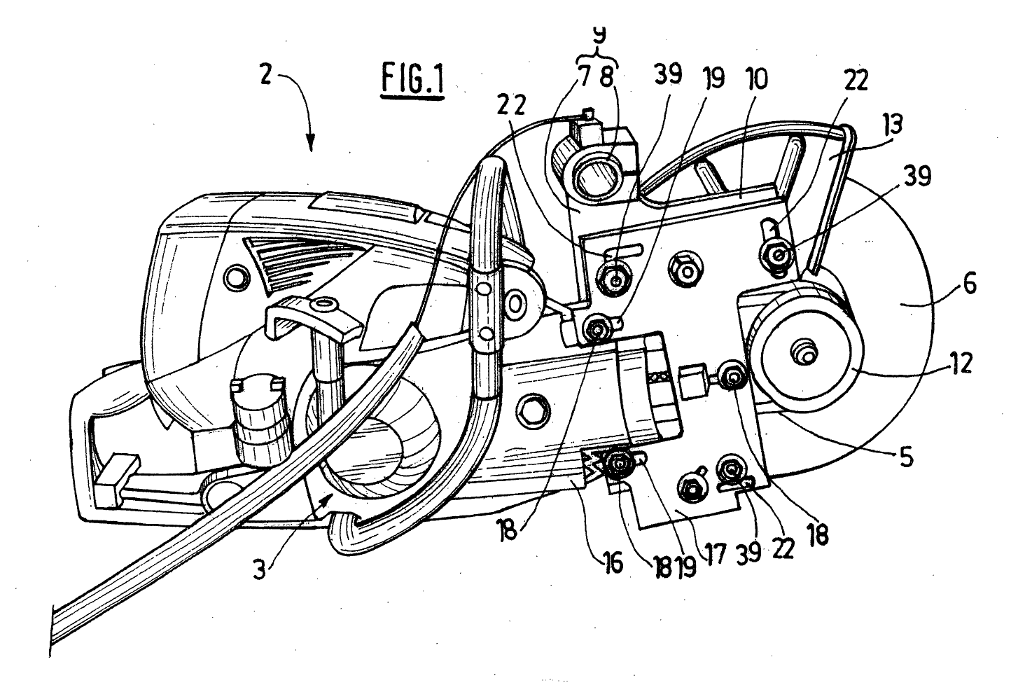

FIG. 1 depicts a cut-off machine 2 for rails or the like, comprising a drive unit 3 driving, via a belt 5, a cutting disk 6 fixed to a disk holder 7. The cutting disk preferably consists of an abrasive disk.

The cut-off machine 2 further comprises a sleeve 8 of axis parallel to the axis of the cutting disk 6, intended to be fixed to a support and guidance device 26 for supporting and guiding the cut-off machine and comprising a vise for attachment to the rail and allowing the cut-off machine to pivot in the plane of the cutting disk and at right angles to the rail to be cut.

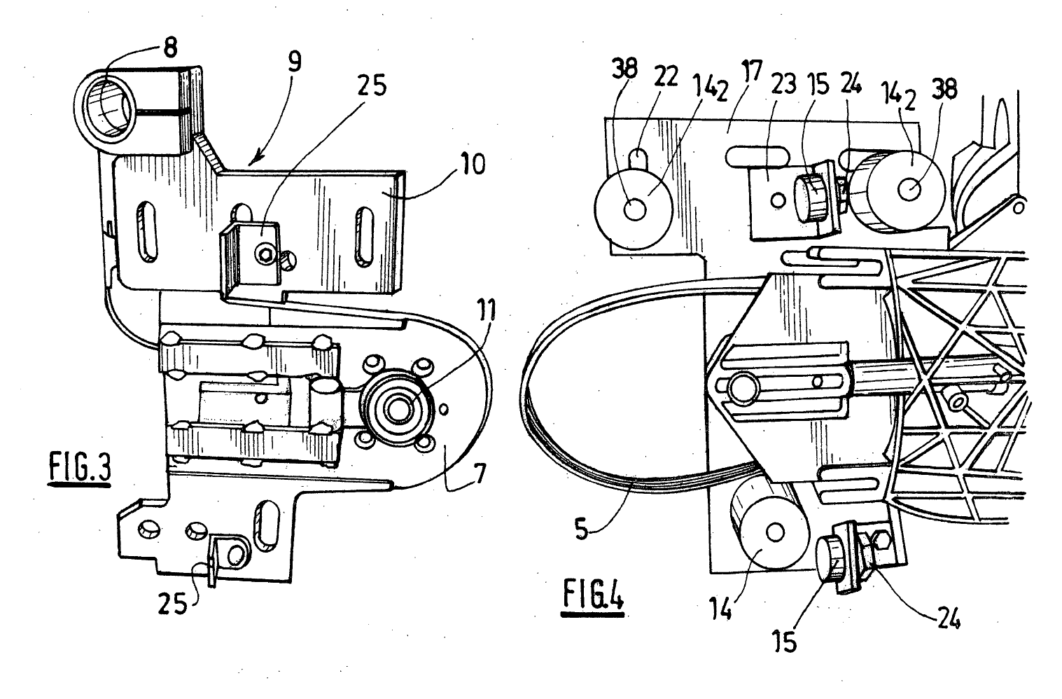

The sleeve 8 and the disk holder 7 form a one-piece assembly 9. As shown more particularly in FIG. 3, the one-piece assembly 9 comprises a mounting plate 10 bearing the sleeve 8 and a bearing 11 for mounting a cutting disk driveshaft. The cutting disk driveshaft projects on each side of the bearing 11, a drive pulley 12 collaborating with the belt 5 of the drive unit 3 being fixed to a first end of the driveshaft and a disk attachment device (not depicted in the figures) being fixed to the other end of the driveshaft.

As shown in FIG. 1, the cut-off machine also comprises a protective disk guard 13 which is fixed to the mounting plate 10.

The one-piece assembly 9 is mounted on the drive unit 3 with the interposition of elastic means.

The elastic means comprise several substantially cylindrical elastic blocks 14, 15 positioned between the drive unit 3 and the mounting plate 10 of the one-piece assembly 9.

The drive unit 3 comprises a first part 16 containing the motor of the cut-off machine and a second part in the form of a plate 17 on which the one-piece assembly 9 is mounted to the side. The second part 17 is movable with respect to the first part 16 so as to allow the cutting disk drive belt 5 to be tensioned sufficiently. Locking means are provided for locking the relative position of the first and second parts. These locking means comprise screw/nut fixing systems 18 intended to slide in oblong holes 19 formed in the second part 17 of the drive unit, the holes running in the direction in which the belt 5 is tensioned.

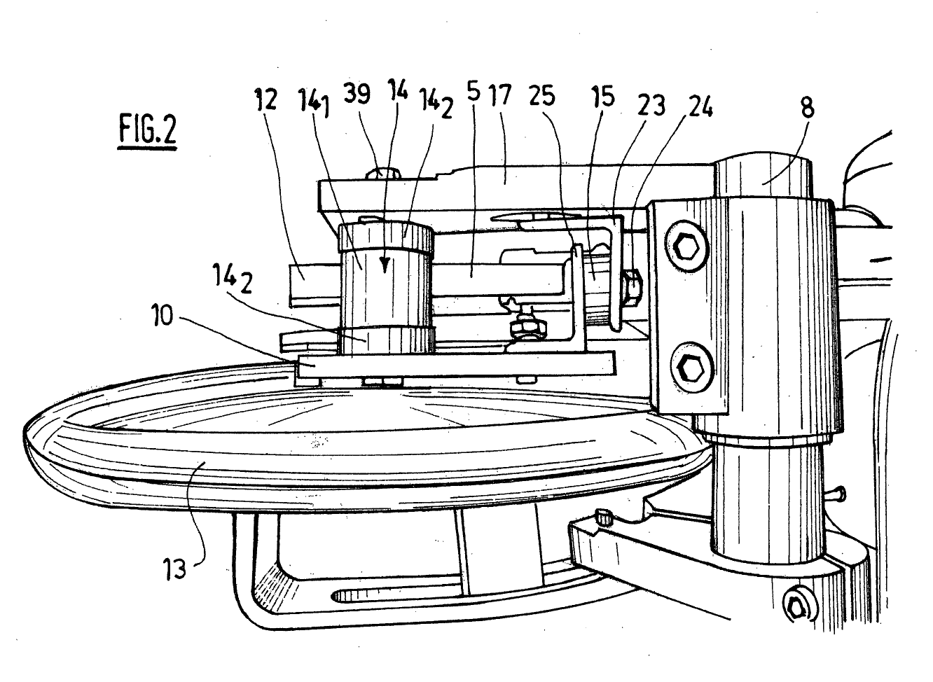

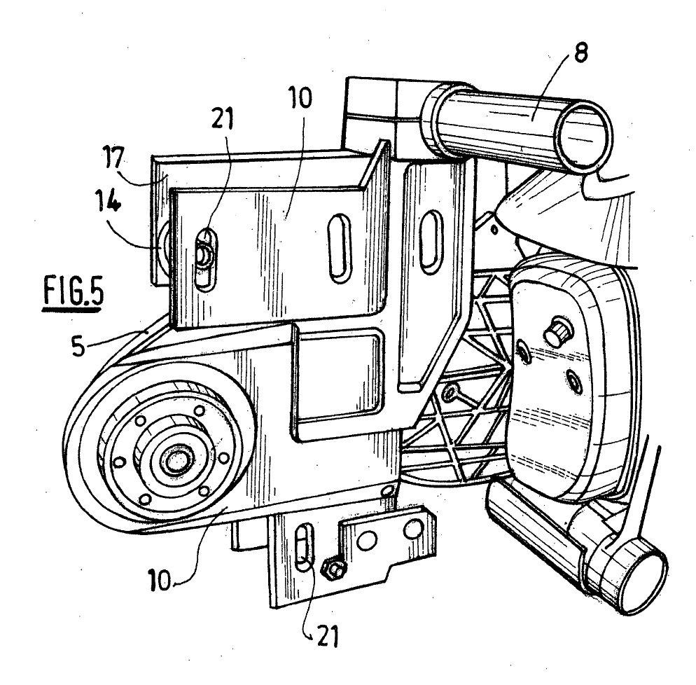

As shown in FIGS. 2 and 4, the cut-off machine 2 comprises three elastic blocks 14 running at right angles to the plane of the cutting disk and two elastic blocks 15 running parallel to the plane of the cutting disk and substantially in the direction in which the belt is tensioned, the blocks 14 and 15 being positioned between the second part 17 of the drive unit and the mounting plate 10 of the one-piece assembly 9.

It should be noted that the elastic blocks 14 have greater elasticity than the elastic blocks 15 so as to avoid an excessive reduction in the inter-axis distance between the axes of the motor pulley and of the drive pulley 12 during cutting, as such an excessive reduction could result in insufficient tensioning of the disk drive belt 5.

Each elastic block 14 is made up of a cylindrical central part 14₁ made of natural rubber and of two cylindrical and metallic end parts 14₂. Each end part has a tapped axial hole 18 opening onto an end face of the block.

Each block 14 is fixed between the mounting plate 10 and the second part 17 of the drive unit 3 via two fixing screws 19, the threaded shank of which passes through a respective opening 21, 22 formed in the mounting plate or in the second part 17 of the drive unit and collaborates with the tapped axial hole in the corresponding end part of the block, and the head of which forms an end stop and collaborates with, respectively, the exterior wall of the mounting plate 10 or of the second part 17.

Each elastic block 15 is made up of a cylindrical part made of natural rubber and of a threaded axial shank fixed to one of the end faces of the cylindrical part of the block.

Each block 15 is fixed between the mounting plate 10 and the second part 17 of the drive unit 3 by inserting the threaded shank of the block 15 into an opening made in the leg of an angle bracket 23 fixed to the interior wall of the second part 17 of the drive unit, a nut 24 being screwed onto the threaded shank of the block in such a way as to fix the block 15 to the angle bracket 23. Another angle bracket 25 is fixed to the interior wall of the mounting plate 10 in such a way as to rest against the opposite face of the block to the nut.

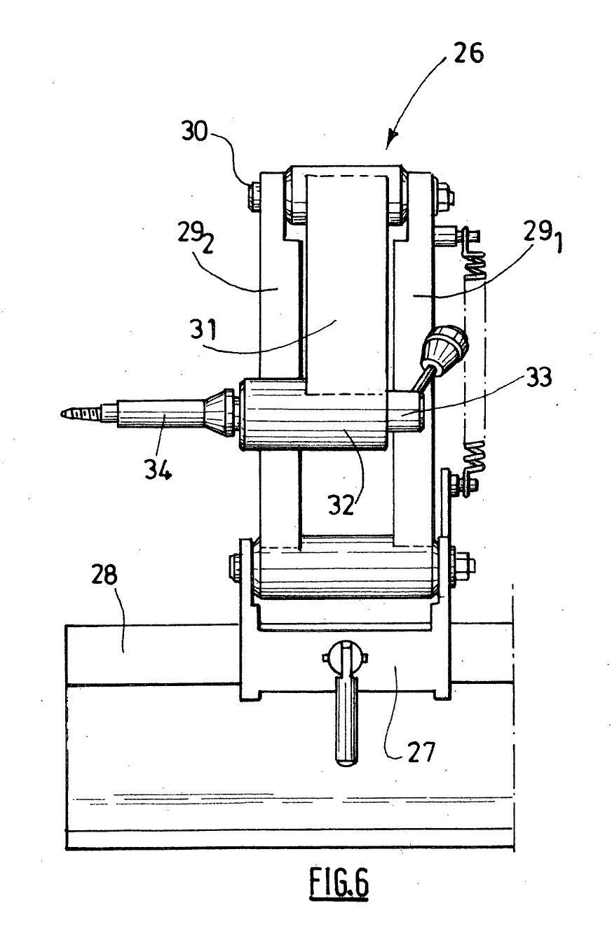

Further, the cut-off machine comprises, as shown in FIG. 6, a support and guidance device 26 for supporting and guiding the cut-off machine and comprising a vise 27 for attachment to the rail 28, secured to a main arm 29₁, 29₂ to the end of which there is articulated, about a pivot pin 30 perpendicular to the plane of the cutting disk and parallel to the plane of the rail, a support arm 31 to which finally the cut-off machine is articulated. The support arm 31 comprises a bearing 32 of axis parallel to the axis of the cutting disk and in which an axially immobilized shaft 33 that projects from the bearing can swivel, the portion 34 of the axle that projects from the bearing being intended to be screwed into the sleeve 8 belonging to the cut-off machine.

As goes without saying, the invention is not restricted only to that embodiment of this rail cut-off machine that is being described hereinabove by way of example but encompasses all variant embodiments thereof. Thus, in particular, the elastic means could consist of springs, hydraulic or gas cylinders, or be made of viscoelastic material.

1. A cut-off machine for rails or the like, comprising a drive unit driving, via a belt, a cutting disk fixed to a disk holder, a sleeve of axis parallel to the axis of the cutting disk, intended to be fixed to a support and guidance device for supporting and guiding the cut-off machine and comprising a vise for attachment to the rail and allowing the cut-off machine to pivot in the plane of the cutting disk, wherein the sleeve and the disk holder form a one-piece assembly mounted on the drive unit with the interposition of elastic means.

2. The cut-off machine for rails or the like as claimed in claim 1, wherein the one-piece assembly comprises a mounting plate bearing the sleeve and a bearing for mounting a cutting disk driveshaft.

3. The cut-off machine for rails or the like as claimed in claim 1, wherein the elastic means have lower elasticity in the direction in which the belt is tensioned than they do in the other directions.

4. The cut-off machine for rails or the like as claimed in claim 2, wherein the cutting disk driveshaft projects on each side of the bearing, a drive pulley collaborating with the belt of the drive unit being fixed to a first end of the driveshaft and a disk attachment device being fixed to the other end of the driveshaft.

5. The cut-off machine for rails or the like as claimed in claim 1, wherein the elastic means comprise at least one elastic element, such as a block or a sheet, positioned between the drive unit and the mounting plate of the one-piece assembly.

6. The cut-off machine for rails or the like as claimed in claim 1, wherein the drive unit comprises a first part containing the motor of the cut-off machine and a second part on which the one-piece assembly is mounted, the second part being movable with respect to the first part so as to allow the cutting disk drive belt to be tensioned sufficiently, locking means being provided for locking the relative position of the first and second parts.

7. The cut-off machine for rails or the like as claimed in claim 6, and which comprises at least one elastic element running at right angles to the plane of the cutting disk, the elastic element being positioned between the second part of the drive unit and the mounting plate of the one-piece assembly.

8. The cut-off machine for rails or the like as claimed in claim 7, and which comprises at least one elastic element running parallel to the plane of the cutting disks, the elastic element being positioned between the second part of the drive unit and the mounting plate of the one-piece assembly.

9. The cut-off machine for rails or the like as claimed in claim 8, wherein each elastic element running at right angles to the plane of the cutting disk has greater elasticity than each elastic element running parallel to the plane of the cutting disk.

10. The cut-off machine for rails or the like as claimed in claim 2, wherein a protective disk guard is fixed to the mounting plate.
